(19) United States
(12) Patent Application Publication
(10) Pub. No.: US 2008/0192208 A1
(43) Pub. Date: Aug. 14, 2008

(54) Projection System

(76) Inventors: Pascal Benoit, Liffre (FR); Jean-Jacques Sacre, Chateaugiron (FR); Frederic Loaec, Rennes (FR)

Correspondence Address: Joseph J. Laks;Thomson Licensing LLC, 2 Independence Way, Patent Operations, PO Box 5312, PRINCETON, NJ, 08543, US

(21) Appl. No.: 11/791,266

(22) PCT Filed: Nov. 29, 2005
(86) PCT No.: PCT/EP2005/056318

§ 371 Date: Mar. 10, 2008

(30) Foreign Application Priority Data
Dec. 3, 2004 (FR) 0412904

(51) Int. Cl. G03B 7/00; G03B 21/28

(52) U.S. Cl. 353/85; 353/99

(57) ABSTRACT

The invention relates to a projection system comprising an image source and an objective lens for producing an imaging beam and producing a first image there behind, wherein the first image is off-axis with respect to the imaging beam optical axis. The inventive system comprises a concave mirror which is arranged after the first image on the imaging beam path and produces a second image on a projection plane from the first image.

### 1. FIELD OF THE INVENTION

The invention relates to the field of image projection.

More precisely, the invention relates to the folding of an imaging beam in a video projector of front projector or rear-projector type.

### 2. PRIOR ART

According to the prior art, projectors have the drawback of being relatively bulky.

To reduce their volume, a projector 1 is provided with a convex hyperbolic mirror, as illustrated in exploded form in FIG. 1, which projector comprises:
an imaging source 13;
an objective 10 illuminated by an imaging beam produced by the source 13;
a convex aspherical mirror 11 which magnifies the image while folding the beam;
a folding mirror 15; and
a rear-projection screen 12.

The objective transmits an imaging beam 14 to the convex aspherical mirror 11, which itself transmits a reflective beam to the folding mirror 15, which reflects the beam onto the screen 12 (so as to make FIG. 1 easier to examine, the beam 14 has been shown not folded by the mirror 15). The mirror 11 is such that, seen from the screen 12, the beam seems to come from a pupillary region A located behind the mirror 11. Such a projector is described in greater detail in the European Patent Application Document published under the number EP1203977.

The rear-projector of FIG. 1 has the drawback of having a relatively large height H below the screen, typically greater than 30 cm. This height is in fact necessary in order to house the objective 10 and to form a correct image on the screen 12 without the imaging beam encountering the objective 10.

### 3. SUMMARY OF THE INVENTION

The object of the invention is to alleviate these drawbacks of the prior art.

More particularly, the objective of the invention is to reduce the height below the rear-projection screen (also call “chin”) or the projection distance in the case of a front projector while still maintaining a small chin (here the distance between the highest level of the projector and the highest level of the screen if the projector is located above the screen).

For this purpose, the invention proposes a projection system comprising an imaging source and an objective that are designed to produce an imaging beam and constructing a first image positioned after the objective, the first image being off-axis relative to the optical axis of the imaging beam, the system being noteworthy in that it includes a concave mirror which is positioned after the first image in the path of the imaging beam and which constructs a second image in a plane of projection from the first image.

Preferably, the concave mirror is an aspherical mirror.

According to one particular feature, the system includes at least a first plane folding mirror between the objective and the concave mirror. Advantageously, the objective comprises:
a diaphragm;
a first lens group; and
a second lens group,
the second lens group being positioned after the diaphragm in the path of the imaging beam and being closer to the first image than the diaphragm.

According to a preferred feature, the distance between the second lens group and the exit pupil of the first lens group is at least three times the distance between the first lens group and the imaging source.

According to an advantageous feature, the second lens group includes at least one meniscus type lens.

According to one particular feature, the second lens group is positioned between the first lens group and the first folding mirror.

According to another feature, the second lens group is positioned between the first folding mirror and the concave mirror.

Advantageously, in a representation of the system without a plane folding mirror, the optical axis of the imaging beam is perpendicular to the plane of projection, being vertical when the imaging beam strikes the concave mirror.

Preferably, the system includes a rear-projection screen in the plane of projection.

Advantageously, the system further includes at least a second plane folding mirror positioned in the path of the imaging beam between the concave mirror and the rear-projection screen.

According to another advantageous feature, the system includes means for front projection on the plane of projection.

Advantageously, the objective comprises a front group comprising three lenses, the lens located in the middle having the opposite power to the outer lenses. Thus, the front group comprises, for example, two convergent lenses flanking a divergent lens or two divergent lenses flanking a convergent lens.

Preferably, the system includes a mask comprising a black zone that absorbs the parasitic rays and a transparent zone placed in the path of the imaging beam after the concave mirror.

According to particular features, the transparent zone is full or corresponds to a cut-out in the mask.

According to a preferred feature, the transparent zone is positioned near the exit pupil of the system comprising the objective and the concave mirror.

### 4. LIST OF THE FIGURES

The invention will be more clearly understood, and other features and advantages will become apparent on reading the following description, which is given with reference to the appended drawings in which:

FIG. 1 illustrates a rear-projector known per se;

FIGS. 2, 3a & 3b are highly schematic simplified diagrams of a rear-projector according to one embodiment of the invention;

FIG. 4 is a highly schematic simplified diagram of a rear-projector according to an alternative embodiment of the invention;

FIG. 5 shows the various images formed by the rear-projector of FIGS. 2 to 4;

FIG. 6 illustrates the optical properties of the rear-projector of FIGS. 2 to 4;

FIGS. 7 to 9 show a rear-projector according to an alternative embodiment of the invention;

FIG. 10 illustrates a front projector according to one particular embodiment of the invention;

FIGS. 11 and 22 show an objective used in the projector of FIG. 2;

FIGS. 12 and 13 are highly schematic simplified diagrams of a rear-projector according to an alternative embodiment of the invention employing a mask;

FIG. 14 shows a highly schematic simplified diagram of a front projector according to an alternative embodiment of the invention employing a mask; and

FIGS. 15 to 21 illustrate the mask employed in the projectors of FIGS. 12 to 14 according to several alternative embodiments of the invention.

### 5. DETAILED DESCRIPTION OF THE INVENTION

The general principle of the invention therefore is based on the use of a concave folding mirror in a rear-projector, thereby making it possible to reduce the height below the screen.

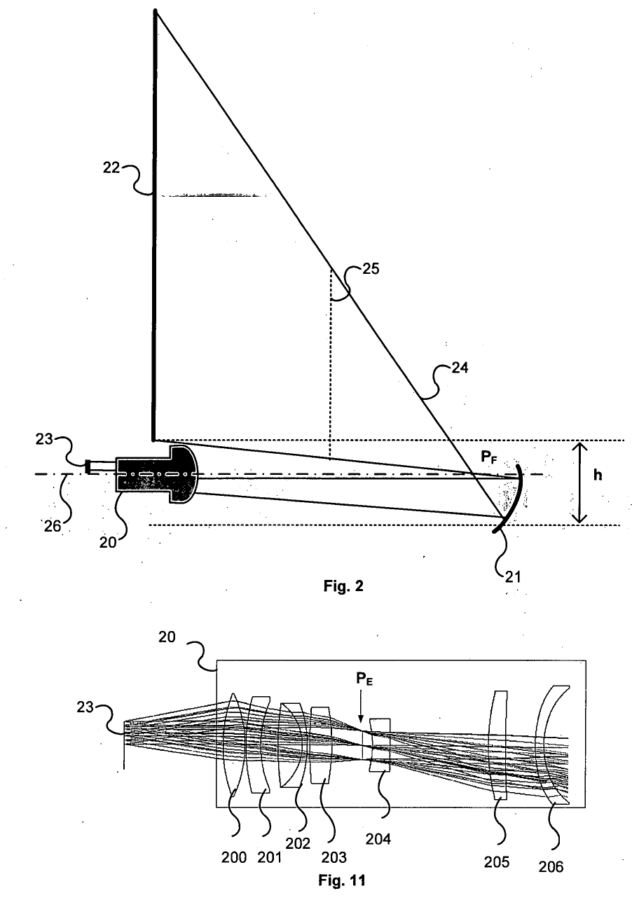

FIG. 2 illustrates a rear-projector with a concave aspherical mirror, in an exploded form, which comprises:
an imaging source 23 (typically an imager illuminated by an illumination beam);
an objective 20 illuminated by an imaging beam produced by the source 23;
a concave aspherical mirror 21 which magnifies the image, while folding the beam;
a folding mirror 25; and
a rear-projection screen 22.

The imager is, for example, a DMD (“Digital Micromirrors Device”) from Texas Instruments™, a transmissive LCD (Liquid Crystal Display) or an LCOS (Liquid Crystal on Silicon) device.

The objective 20 transmits an imaging beam 24 to the concave aspherical mirror 21, which itself transmits a reflective beam to a folding mirror 25, which reflects the beam onto a plane of projection where the screen 22 is positioned (to make FIG. 2 easier to examine, the beam 24 has been shown not folded by the mirror 25). The optical part of the projector has an optical axis 26, the optical beam 24 produced being off-axis (as is therefore the imager) with respect to this axis 26. The mirror 11 is such that, seen from the screen 12, the beam seems to come from a pupillary region, corresponding to a pupil P_{F} located between the mirror 21 and the screen 22 in the path of the imaging beam 24.

The concave aspherical mirror 21 has an axisymmetric (revolution) shape, the reflecting surface of which is given by the following aspherical surface equation:

$$Z ( r ) = \frac{\frac{{r}^{2}}{R}}{1 + \sqrt{1 - ( 1 + c ) {( \frac{r}{R} )}^{2}}} + {a}_{1} r + {a}_{2} {r}^{2} + {a}_{3} {r}^{3} + {a}_{4} {r}^{4} {a}_{5} {r}^{5} + {a}_{6} {r}^{6} + …$$

where:
r represents the distance of a given point from the optical axis, the axis of the mirror 21 being positioned on the optical axis of the objective;
Z represents the distance of this point from a plane perpendicular to the optical axis;
the coefficient c is the conic;
the parameter R corresponds to the radius of curvature of the surface; and
the parameters a₁, a₂, . . . aᵢ are asphericity coefficients of order 1, 2 and i, respectively.

FIG. 11 shows the objective 20 in greater detail.

The objective comprises a rear group of lenses 201 to 203 and a front group of lenses 204 to 206.

The last lens 206 of the objective 20 in the path of the imaging beam is preferably an aspherical meniscus lens, the shape of which is matched to the parameters of the concave mirror 21. Its shape is therefore preferably given by an aspherical surface equation as shown above.

As an illustration, in one particular embodiment the radius R of the concave mirror 21 is 60, the parameters c and a₁ to a₈ are, respectively, the following: −1.59311 mm; 0; 0; −8.94×10⁻⁶; 0; 1.64×10⁻⁹; −9.74×10⁻¹³, −7.84×10⁻¹⁴; and 2.31×10⁻¹⁶. The radius R of the first surface (the imager side) of the meniscus 206 is 44.94711 mm, and the parameters c and a₁ to a₈ have, respectively, the following values: 0; 0; 0; −3.1×10⁻⁹; 2.88×10⁻⁵; 1.96×10⁻⁶; 7.14×10⁻⁸; 4.15×10⁻¹⁰; and −4.30×10⁻¹⁰. The radius R of the second surface (the imager side) of the meniscus 206 is 29.49554 mm and the parameters c and a₁ to a₈ have, respectively, the following values: 0; 0; 0; −2.7×10⁻⁴; 9.97×10⁻⁶; 6.34×10⁻⁷; —1.41×10⁻⁷; 8.98×10⁻⁹; and −1.78×10⁻¹⁰.

Advantageously, according to the invention, the front lens group comprises three lenses, the two lenses located in the outer positions each having an opposite power to the lens located in the middle. Thus, the front group contributes to generating curvature of the intermediate image so that the projected image is plane, while comprising a number of weak lenses. This makes it easier to manufacture it and to reduce its cost.

Thus, the front lens group illustrated in FIG. 11 comprises two negative power lenses 204 and 106 (divergent lenses) surrounding a positive power lens 205 (convergent lens).

According to an alternative embodiment of the invention, the front lens group of the objective comprises two positive (convergent) lenses surrounding a negative lens. An objective 130 comprising such a front group and able to replace the objective 20 is illustrated in FIG. 22.

The objective 130 comprises a rear group of lenses 131 to 138 and a front group of lenses 139 to 141, these lens groups being placed on either side of the exit pupil P_{E} of the objective.

As an illustration, the characteristics of the objective 130 are summarized in the following table (the rays, thickness and diameter being expressed in millimeters and the material of the lenses 132 to 141 corresponding to the references of the products supplied by the OHARA® company):

| | Radius of | | | |
|---|---|---|---|---|
| | curvature | Thickness | | Diameter |
| Lens | (in mm) | (in mm) | Material | (in mm) |
| 131 | 36.43399 | 16.245 | acrylic | 48 |
| | −104.8294 | 0.500 | | 48 |
| 132 | 206.176 | 9.538 | | 46 |
| 133 | −48.868 | 5.389 | | 46 |
| 134 | 33.95 | 14.933 | | 46 |
| | −83.67 | 0.500 | | 46 |
| 135 | Infinity | 12.658 | | 36 |
| 136 | −22.648 | 2.626 | | 36 |
| | Infinity | 0.500 | | 36 |
| 137 | 47.785 | 9.381 | | 28 |
| 138 | −27.09 | 2.493 | | 28 |
| | Infinity | 5.974 | | 28 |
| P_{E} | Infinity | 41.998 | | 16.58 |
| 139 | 33.768 | 6.849 | | 38 |
| | 120.842 | 14.926 | | 38 |
| 140 | −77.81 | 16.188 | | 41 |
| | 46.246 | 24.299 | | 41 |
| 141 | −86.258 | 9.816 | | 60 |
| | −41.781 | — | | 60 |

The rear-projector of FIG. 2 has the advantage of a relatively small height h below the screen, typically between 10 and 20 cm for a screen with a diagonal of about 1.50 m. This height h is in fact sufficient to house the objective 20 and the mirror 21, while still forming a correct image on the screen 22 without the imaging beam 24 encountering the objective 20. Preferably, the height h is equal to one fifth (approximately) of the height of the screen. More precisely, the height h is less than or equal to the height of the screen divided by 5.

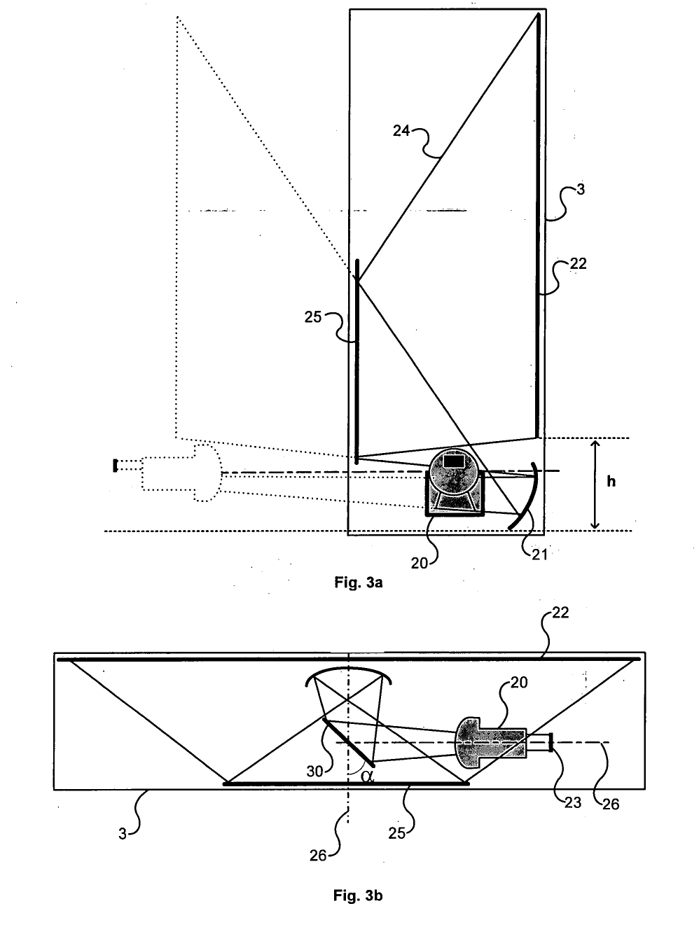

FIGS. 3a and 3b illustrate a side view and a top view, respectively, of the rear-projector 3 as shown schematically in FIG. 2.

To reduce the depth of the rear-projector 3, a folding mirror 30 is interposed between the objective 20 and the concave mirror 21. The dotted lines and the full lines represent, respectively, the elements with the beam 24 not folded and folded, respectively. The mirror 30 is vertical (that is to say parallel to the screen 22), the optical axis of the beam 24 before the mirror 21 being horizontal. The long side of the imager 23 of the rear-projector 3 is horizontal (for a vertical projection screen 22 whose long side is horizontal).

The objective 20 is placed along the side and folded preferably in a horizontal plane placed along the side, preferably with an axis parallel to the screen 22, thereby making it possible to reduce the depth of the rear-projector 3. The angle α that the mirror 30 makes with a normal screen 22 depends on the angle that the optical axis of the objective 20 makes with the screen 22. When the objective 20 is parallel to the screen, the angle α is equal to 45°. The distance between the objective 20 and the mirror 30 is such that the beam 24 does not encounter the objective 20.

In general, all the optical axes of the various elements of the unfolded projection system are perpendicular to the plane of projection, assumed to be vertical. They are therefore horizontal (for a system as shown in unfolded form, with the exception of the folding due to the concave folding mirror).

In the projector 3, the reel axis of the objective 20 remains horizontal, the screen 22 being vertical. The projector 3 has a relatively small “chin”, that is to say a relatively small value of h.

However, in alternative embodiments that allow the illumination part to be housed more easily (inclination of the optical illumination core, lamp casing, electronic card attached to the imager 23), the reel axis of the objective is inclined. This is because the axis of one element of the projection system may become non-horizontal after being folded by a folding mirror. For example, if the large mirror is inclined, all the following elements will also be inclined through twice the angle, in particular the concave mirror.

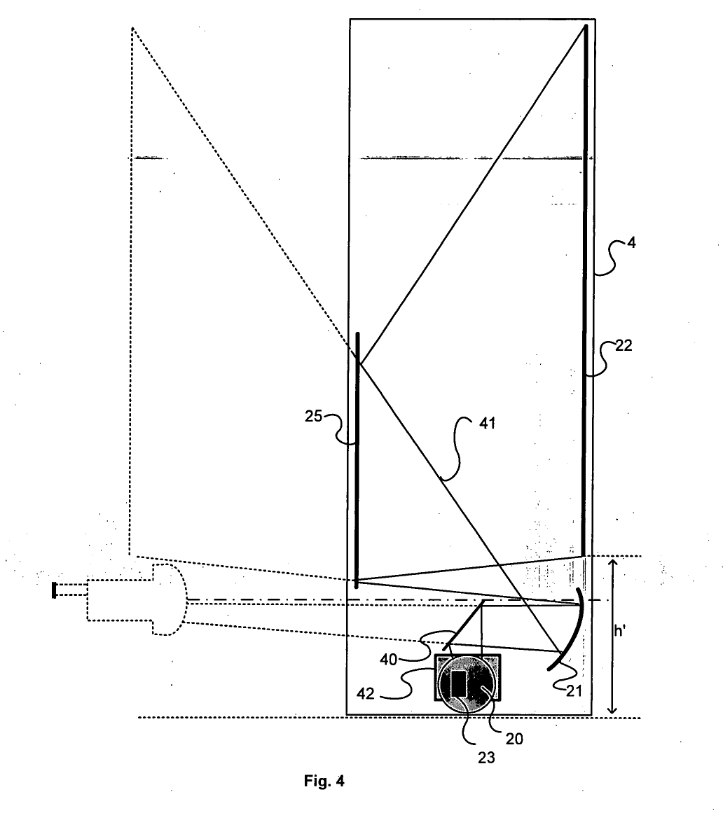

Thus, FIG. 4 illustrates a rear-projector 4 according to an alternative embodiment of the invention with two folding mirrors 40 and 42. The rear-projector 4 comprises elements similar to the components of the rear-projector 3, which bear the same references (especially the imaging source 23, the objective 20, the concave mirror 21, the folding mirror 25 and the screen 22).

The two folding mirrors 40 and 42 are positioned between the objective 20 and the mirror 21. The axis of the objective 20 of the rear-projector 4, when folded, is not horizontal. The imaging beam coming from the objective 20 firstly illuminates the mirror 42, which is inclined at 45° to the optical axis and perpendicular to the screen 4. The beam is thus reflected in a direction parallel to the screen 4, its optical axis being in a plane normal to the screen 4. Next, the beam reflected by the mirror 42 illuminates the mirror 40 which is inclined at 45° to the optical axis and the normal of which is perpendicular to the screen 4. The beam is thus reflected in a direction perpendicular to the screen 4 in order to illuminate the concave mirror 21.

In an alternative embodiment of the invention, the axis of the objective 20 of the rear-projector 4, when folded, is not horizontal the rear-projector 4 comprising one or more folding mirrors positioned between the objective and the concave mirror 21 in order to send the beam in a direction approximately perpendicular, and preferably perpendicular, to the screen 21.

According to other alternative embodiments of the invention, the axis of the imaging beam illuminating the concave mirror positioned after the first image in the path of the imaging beam is not horizontal. The shape of the concave mirror is then calculated in order to construct a second image in a plane of projection corresponding to the projection screen.

The long side of the imager 23 of the rear-projector 4 is vertical (for a vertical projection screen 22 with a horizontal long side).

The rear-projector 4 obviates the size constraint of the lenses of the objective 20 in order for it not to intersect the return beam 41 from the mirror 21. In the configuration of the rear-projector 4, it is also possible to use larger lenses, since the objective is below the beam 41 (there is easier separation of the fields).

Preferably, the height h′ below the screen of the rear-projector 4 is equal to one fifth (approximately) of the height of the screen. More precisely, the height h′ is less than or equal to the height of the screen divided by 5. It may also depend on the magnification of the objective 20 or of the concave mirror 21, and on the illumination system (the size of the lamp's reflector). Thus, for a projector with a 50″ screen and DMD HD3, the height h′ is, for example, less than 20 cm and typically equal to 12 cm.

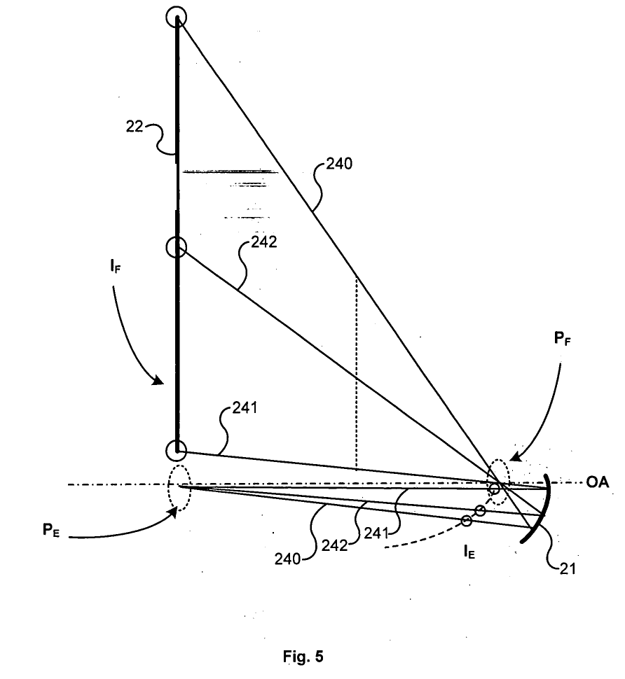

FIG. 5 shows the various images formed by the rear-projector 3 or 4 (the imaging beams being shown unfolded).

The ray 242 represents the central ray of the imaging beam 24 and the rays 240 and 241 are two extreme rays.

The exit pupil P_{E} of the objective 20 forms an image I_{E} located in front of the mirror 21 in the path of the beam 24. The objective 20 magnifies the object image formed on the imager 23 in order to form the image I_{E} with a magnification factor M. The magnification factor M associated with the objective 20 is preferably between 1 and 10, and even more preferably between 5 and 9.

The mirror 21 associates the exit pupil P_{E} with a pupil P_{F} where the rays of the imaging beam cross over in a relatively small area. The shape of the mirror 21 is calculated to create an image I_{M} corresponding to the image I_{E} projected on a plane of projection where the screen 22 is located. The concave mirror 21 magnifies the image I_{E} in order to form the image I_{M} with a magnification factor M′. The magnification factor M′ associated with the concave mirror 21 is preferably greater than the magnification factor M associated with the objective 20.

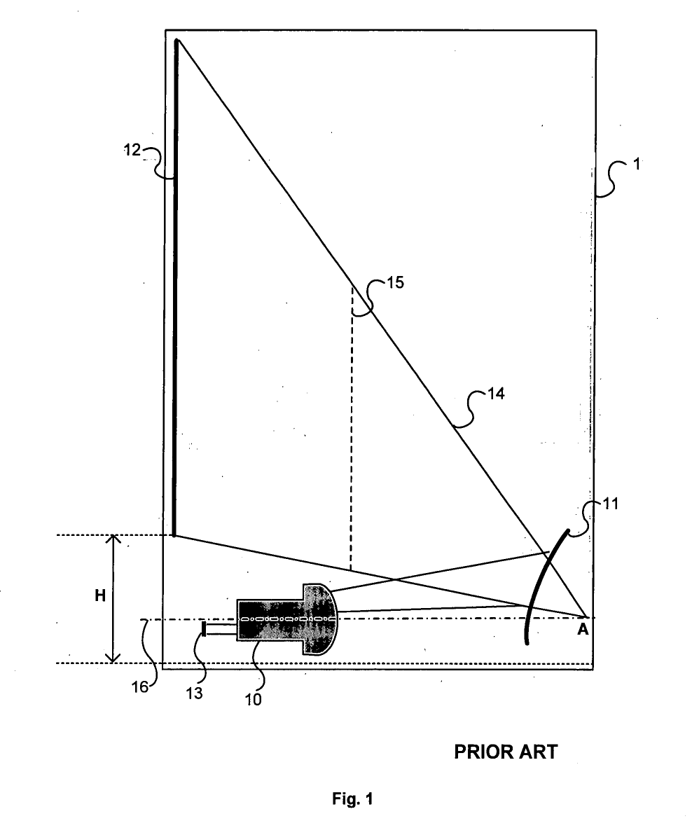

The use of a concave mirror 21 positioned after the first image in the path of said imaging beam has the advantage that the lower portion of the imaging beam, corresponding to the ray 241 is relatively high (relative to the corresponding ray in FIG. 1) and therefore allows optical elements close to the screen (in the case of a rear-projector) to be housed more easily, without disturbing the propagation of the beams between the concave mirror and the screen.

According to an alternative embodiment, the magnification factor M′ associated with the concave mirror 21 is greater than 10.

The concave mirror 21 is preferably located below the optical axis. Preferably, the optical axis of the system in front of the concave mirror 21 is horizontal and close to the bottom of the screen 22.

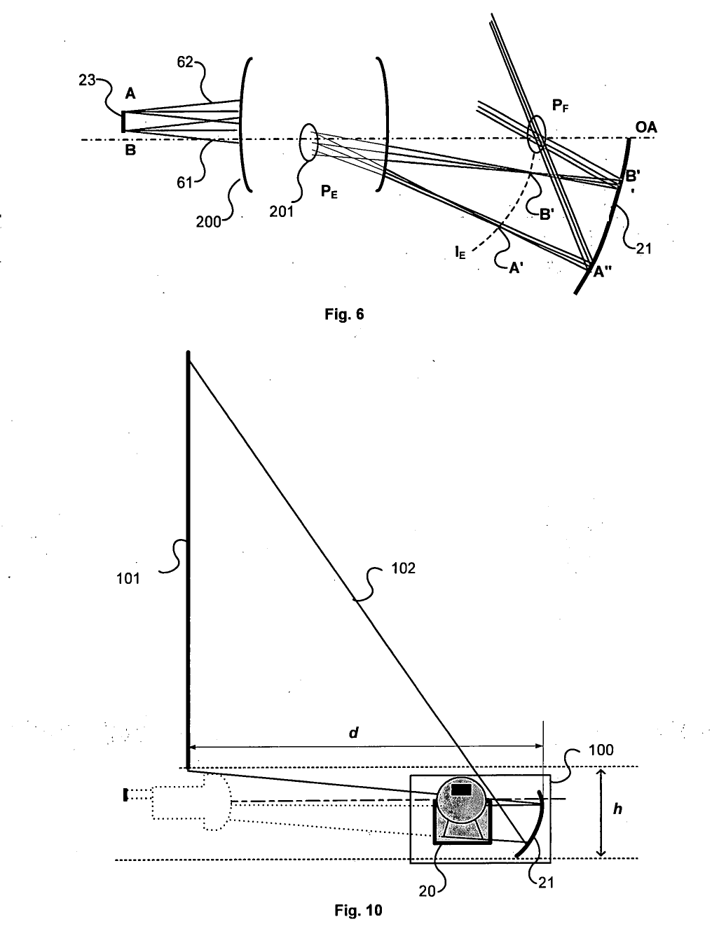

FIG. 6 illustrates the optical properties of the rear-projector 3. More precisely, the imaging system 23 creates a first image comprising two points A and B indicated by way of illustration. Emanating from these two points A and B, are two beams 62 and 61, respectively, which form, after passing through the objective 20 comprising at least one lens 200 and an exit pupil P_{E} 201, two points A′ and B′ belonging to the image I_{E} created by the objective 20.

The beams 62 and 61 are reflected, respectively, in non-discrete regions A″ and B′ on the mirror 21 and converge on a region corresponding to the pupil P_{F}, the image of the pupil P_{E} via the mirror 21.

It should be noted that the pupil P_{F} is relatively close to the mirror 21 and that the pupil P_{E} is further away from the mirror 21. Typically, the distance of the exit pupillary region P_{F} from the vertex of the concave mirror 21 is between 25 mm and 60 mm. Preferably, the distance of the exit pupil 201 from the concave mirror 21 must be as large as possible.

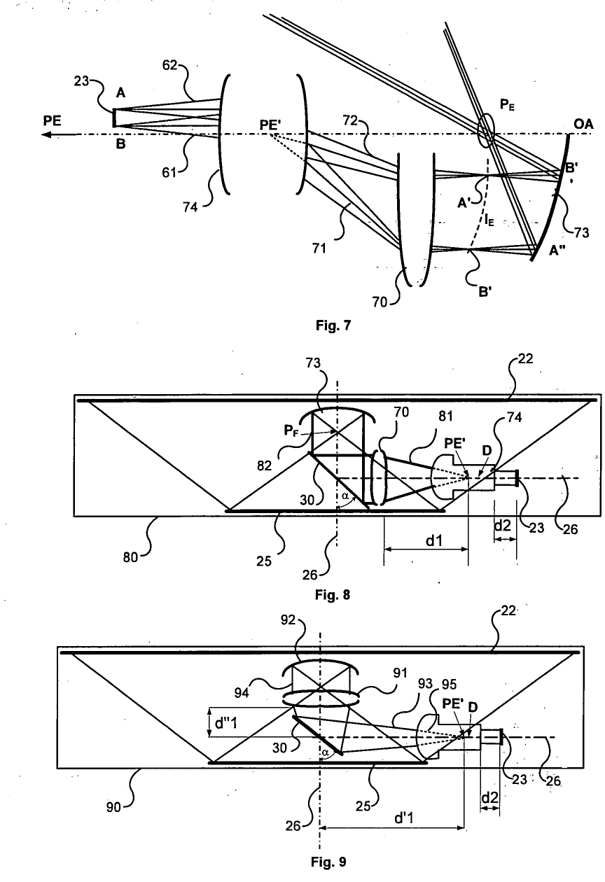

FIG. 7 shows schematically, and in unfolded form, part of the rear-projector 80 according to an alternative embodiment of the invention.

The rear-projector 80 comprises similar components to the components of the projectors 3 and 4 (especially the components 22, 23, 25 and 30). These components bear the same references, but will not be described further.

The rear-projector 80 comprises an objective comprising a diaphragm D, a first lens group having at least one lens 70 and a second lens group having at least one lens 74. The second lens group is positioned after the diaphragm D in the path of the imaging beam and is closer to the image I_{E} than the diaphragm D. Preferably, the distance d, between the second lens group 70 and the exit pupil P_{E}′ of the first lens group 74 is at least three times the distance d₂ between the first lens group 74 and the imaging source 23.

The exit pupil P_{E}′ corresponds to an image of the diaphragm D formed by the first lens group 70. The second lens group 74 makes it possible to position the exit pupil P_{E} of the objective of the projector 80 substantially at infinity. Thus, the second lens group 74 rectifies the rays of the imaging beam (for example the rays 72 and 71 corresponding to the points A and B) and makes it possible to reduce the size of the concave mirror 73 that replaces the mirror 21, its shape moreover being similar.

The second lens group 70 also applies optical corrections assumed by the mirror 21 according to the other embodiments described above. In particular, it is possible to reduce astigmatism and certain optical distortions. It also increases the aperture of the beam (aperture at 2.8). The mirror 73 has a curvature that therefore essentially makes it possible to magnify the image I_{E} and to obtain a plane image in the plane of projection.

The concave aspherical mirror 73 has a shape the reflecting surface of which is given by the following equation:

$$Z ( r ) = \frac{\frac{{r}^{2}}{R}}{1 + \sqrt{1 - ( 1 + c ) {( \frac{r}{R} )}^{2}}} + {a}_{1} r + {a}_{2} {r}^{2} + {a}_{3} {r}^{3} + {a}_{4} {r}^{4} {a}_{5} {r}^{5} + {a}_{6} {r}^{6} + …$$

where:
r represents the distance of a given point from the optical axis, the axis of the mirror 74 being positioned on the optical axis of the objective;
Z represents the distance of this point from a plane perpendicular to the optical axis;
the coefficient c is the conic;
the parameter R corresponds to the radius of curvature of the surface; and
the parameters aᵢ are asphericity coefficients of order i, respectively.

The second lens group 70 comprises one or more lenses and consists, for example, of one or more meniscus lenses (a lens group with several meniscus lenses being easier to produce). Preferably, the second lens group 70 has optical properties matched to the parameters of the concave mirror 73. Its components preferably have a shape that follows an aspherical surface equation as shown above.

As an illustration, in one particular embodiment, the radius R of the concave mirror 73 is equal to −56.202 mm, the parameters c, and a₁ to a₈ are, respectively, the following: −3.32197; 0; 0; −1.06×10⁻⁵; 0; −2.20×10⁻⁹; 6.68×10⁻¹¹; −1.06×10⁻¹² and 5.91×10⁻¹⁵.

Again as an illustration, the lens group 70 is considered to consist of a meniscus. The radius R of the first surface (the imager side) of the meniscus of the lens group 70 is assumed to be infinite, the parameters c, and a₁ to a₈ are, respectively, the following: 0; 0; −0.00811; 7.60×10⁻⁵; −6.43×10⁻⁶; 1.57×10⁻⁷; −1.53×10⁻⁹; 0; and 0. The radius R of the second surface (the image the meniscus of the lens group is assumed to be infinite, the parameters c, and a₁ to a₈ having, respectively, the following values: 0; 0; −0.01058; −1.77×10⁻⁵; −2.88×10⁻⁶; 8.41×10⁻⁸; −9.96×10⁻¹⁰; 0; and 0.

The first lens group 74 comprises a rear group of one or more lenses located in front of the diaphragm in the path of the imaging beam. According to alternative embodiments, it also includes a front group consisting of one or more lenses located after the diaphragm in the path of the imaging beam.

Moreover, an image I_{E} is formed in front of the mirror 73, and the mirror 73 associates the exit pupil P_{E} with a pupil P_{F} where the rays of the imaging beam intersect in a relatively small area. The shape of the mirror 73 and the arrangement of the second lens group 70 are calculated to create an image I_{M} corresponding to the image I_{E} in a plane of projection in which the projection screen 22 lies.

FIG. 8 illustrates schematically a top view of the rear-projector 80.

In the projector 80, the second lens group 70 is positioned between the folding mirror 30 and the first lens group 74. Thus, the imager 23 transmits an imaging beam 81 through the first lens group 74 to the second lens group 70. The second lens group 70 corrects the imaging beam 81 into an imaging beam 82 which is reflected by the folding mirror 30 onto the concave mirror 73.

The optical axis of the imaging beam 81 is horizontal and parallel to the bottom of the image projected on the projection screen (as in the embodiment of the rear-projector 3). In an alternative embodiment, the optical axis of the imaging beam 81 is inclined, like the axis of the imaging beam coming from the objective of the rear-projector 4, the mirror 30 being replaced with the mirror 40 of the rear-projector 4, as illustrated in FIG. 4.

FIG. 9 illustrates schematically a top view of a rear-projector 90 corresponding to an alternative embodiment of the rear-projector 80.

The rear-projector 90 comprises components similar to the components of the rear-projector 80, the mirror 73, the first lens group 74 and the second lens group 70 being replaced, respectively, by a concave mirror 92, a first lens group consisting of at least one lens 95 and a second lens group consisting of at least one lens 91. These similar components bear the same references and will not be described further.

The objective of the rear-projector 90 therefore comprises a diaphragm D, the first lens group 74 and the second lens group 95. The second lens group 95 is positioned after the diaphragm D in the path of the imaging beam and is closer to the image I_{E} than the diaphragm D. Preferably, the optical distance between the second lens group 95 (corresponding to the sum of the distances d′₁ and d″₁) and the exit pupil P_{E}′ of the first lens group 74 is at least three times the distance d₂ between the first lens group 74 and the imaging source 23.

The concave mirror 92 and the second lens group consisting of at least one lens 91 provides the same functions as the mirror 73 and the first lens group 74, respectively. The shape of the mirror 92 and the optical characteristics of the second lens group 91 are matched approximately to these two components.

In the projector 90, the second lens group 91 is positioned between the folding mirror 30 and the concave mirror 92. Thus, the imager 23 transmits an imaging beam 93 through the first lens group 95, the beam 93 being reflected by the folding mirror 30 onto the second lens group 91. The second lens group 91 corrects the imaging beam 93 into an imaging beam 92 which is transmitted to the concave mirror 73.

The optical axis of the imaging beam 93 is horizontal and parallel to the bottom of the image projected onto the projection screen (as in the embodiment of the rear-projector 3). In an alternative embodiment, the optical axis of the imaging beam 93 before being reflected by one of the plane or concave folding mirrors is inclined to the plane of projection.

According to an alternative embodiment of the rear-projector 90, the plane folding mirror 30 is replaced with two mirrors similar to the mirrors 40 and 42 of the rear-projector 4, these two mirrors being positioned between the first lens group 74 and the second lens group 95 so as to reduce the size of the rear-projector. Such an embodiment is compatible with a concave mirror 92 similar to the mirror 73, and a second lens group 95 consists of a single meniscus, similar to the lens group 70, precise characteristics of these components having been mentioned above by way of illustration.

FIG. 10 shows a front video projector 100 according to an alternative embodiment of the invention.

The projector 100 comprises the optical components of the projector 3 except for the projection screen 22 and the folding mirror 25.

More precisely, the projector 100 comprises components similar to the components 20, 23, 30 and 21 of the projector 3, which bear the same references and will not be described further. The concave mirror 21 of the projector 100 transmits an imaging beam 102 to a screen 101 lying in a plane of projection perpendicular to the optical axis of the unfolded system, the concave mirror 21 constructing a second image in the plane of projection from a first image located between the objective 20 and the mirror 21. It should be noted that the plane of projection may be very close to the projector 100—the distance separating the optical centre of the concave mirror 21 from the plane of projection is preferably less than 1 m and even more preferably less than 50 cm.

Moreover, the chin h (the distance separating the image projected onto the screen 101 from the lowermost point of the projector 100 (assuming an image projected from the bottom up) is relatively small—it is preferably less than one fifth of the height of the projected image.

Moreover, the rear-projectors according to the various embodiments of the invention as explained above may be adapted to front projectors, a person skilled in the art replacing the rear-projection screen with a front projection screen and possibly omitting the folding mirror or mirrors located after the concave mirror in the path of the imaging beam.

According to another aspect of the invention, a mask is positioned near a small pupillary zone, the zone being placed between the objective and the screen in the path of the imaging beam. Such a mask may be employed when the exit pupil of the system is real. The mask makes it possible in particular to limit, even eliminate, the parasitic rays and/or to prevent dust from being deposited on the objective, the concave mirror and the optical elements close to the objective. As indicated above, such a pupil P_{F} is in particular obtained when the projector employs a concave mirror for constructing an image on a plane of projection.

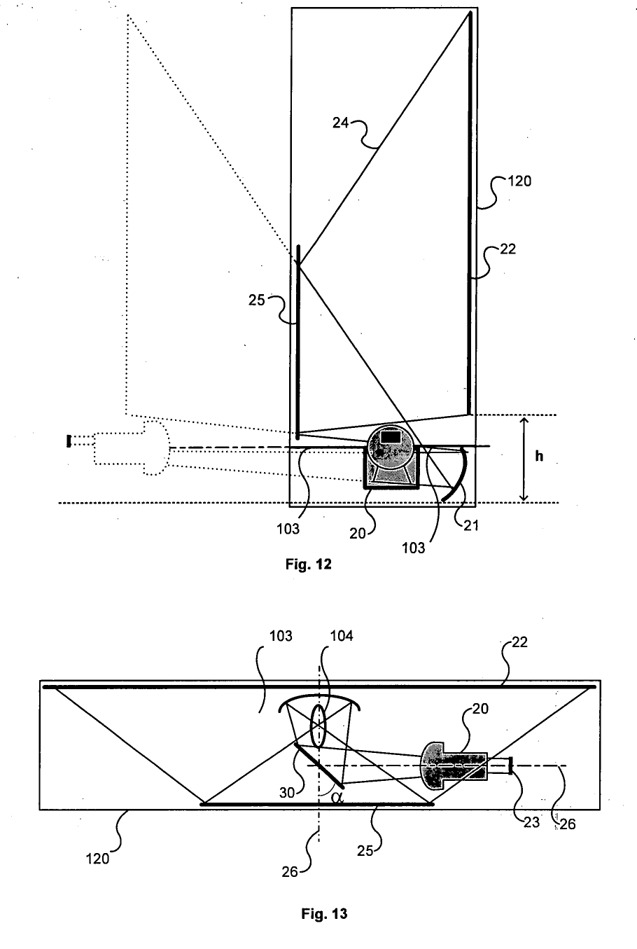

FIGS. 12 and 13 show a rear-projector 120 in a side view and in a plan view respectively. The rear-projector 120 comprises all the elements of the rear-projector 3, which bear the same references and will not be described further, and a mask 103.

Advantageously, the mask 103 is a sheet of glass or plastic that includes a transparent zone 104 through which the projection beam 24 can pass. The thickness of the mask 103 is chosen to be as small as possible, preferably less than 2 mm and even more preferably equal to 1 mm or less.

As illustrated in FIG. 19, rays 113 to 115 of the beam 24 pass through the transparent zone 104 while being refracted by the mask 103. Outside the transparent zone 104, the mask 103 is black and absorbs the parasitic rays. The black peripheral zone corresponds to a zone of the mask which is either bulk-tinted or has been treated on one or both sides of the mask. Preferably, the transparent zone has undergone an antireflection treatment using techniques well known to those skilled in the art. The mask 103 preferably extends as far as the boundary of the projector box and thus isolates the objective, the concave mirror and the corresponding imager from dust and/or eliminates (or reduces) the parasitic rays coming from these elements or from the outside. The boundary of the transparent zone of the mask 103 illustrated comprises walls normal to the surface of the mask. According to an advantageous alternative embodiment of the mask 103, the boundary of the transparent zone of the mask comprises inclined walls so as to converge on the path of the imaging beam.

According to an alternative embodiment, the transparent zone of the mask is inclined to the axis of the zone imaging beam so as to reduce its angle of incidence and therefore to reduce any reflection of the imaging beam on the transparent zone.

Thus, FIG. 21 illustrates a mask 121 that is a variant of the mask 103. The mask 121 comprises a black upper face 125 and a black lower face 126 which surround a transparent zone 127. The faces 125 and 126 are offset along a direction normal to the mask 121 so as to include at most just the extreme rays 113 and 115 that are tangent or close (preferably at a distance of 2 mm or less) to the faces 125 and 126. Thus, according to the embodiment illustrated, the faces 125 and 126 are not offset and the boundary of the transparent zone of the mask 121 has inclined walls so as to converge on the path of the imaging beam. According to an alternative embodiment of the mask, the walls of the transparent zone are normal to the surface of the mask. According to another alternative embodiment, only one face of the mask is black. This face is preferably on the entry face side of the imaging beam.

According to an alternative embodiment of the masks 103 and 116, the transparent zone is made of glass or plastic, and the black zone is made of any other material.

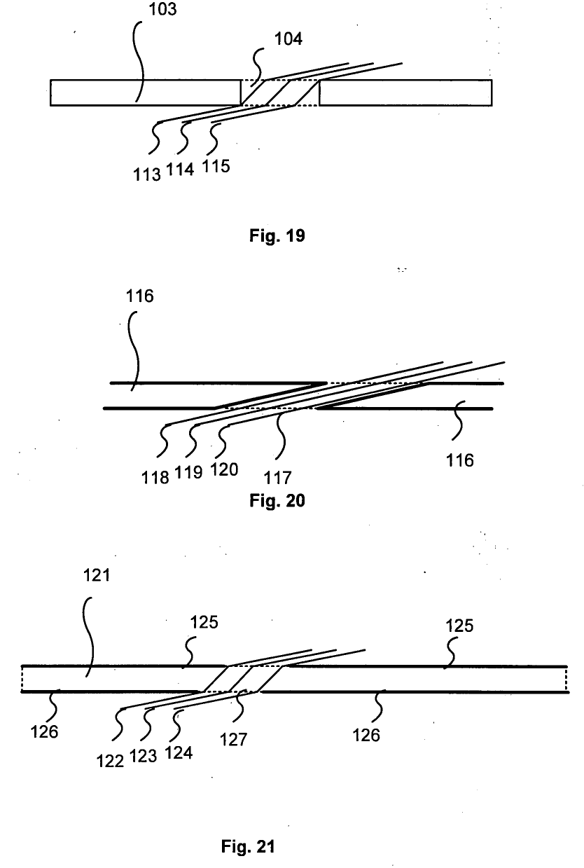

FIG. 20 illustrates a black mask 116 (a variant of the mask 103) with a cut-out transparent zone 117. The rays 113 to 115 of the beam 24 pass through the transparent zone 117 without being deflected or absorbed.

The transparent zone of the masks 103, 121 and 116 is preferably adjusted to the size of the beam 24 and located close to the pupillary zone (or pupil P_{F} of the system comprising the objective and the concave mirror) lying between the objective and the plane of projection (typically at a distance of 5 mm or less from the pupillary zone P_{F} corresponding to the exit pupil of the system comprising the objective and the concave mirror).

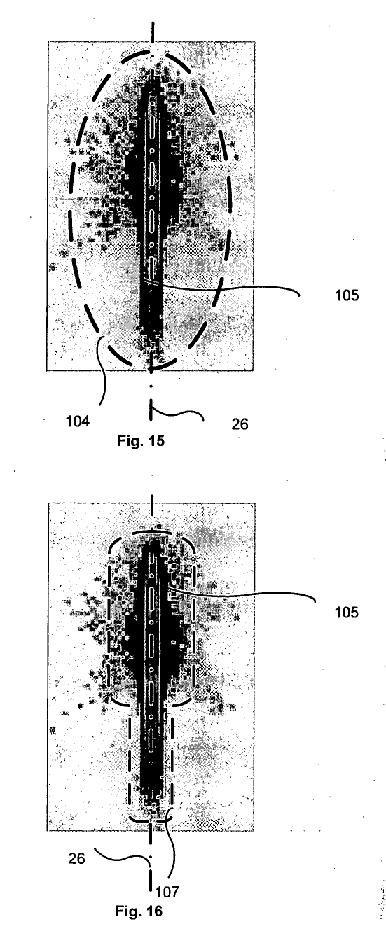

To make it easier to manufacture the masks, the transparent zone has a simple geometrical shape. Thus, FIG. 15 illustrates the transparent zone 104 surrounding the imprint of the pupillary zone P_{F} 105 when the mask is placed on the optical axis 26. The imprint of the pupillary zone 105 (or of the beam 24) is symmetrical with respect to the axis 26 and somewhat elongated along this axis. Thus, as an illustration, the transparent zone is elliptical, centered on the axis 106, the major axis of which (placed on the axis 106) and the minor axis of which have lengths of about 50 mm and 30 mm respectively.

According to a variant of the mask, illustrated in FIG. 16, a transparent zone 107 includes the imprint of the pupillary zone 105 more finely. Thus, one end of the zone 107 is narrower (for example with a Width of 10 mm) than the other end (for example with a width of 20 mm).

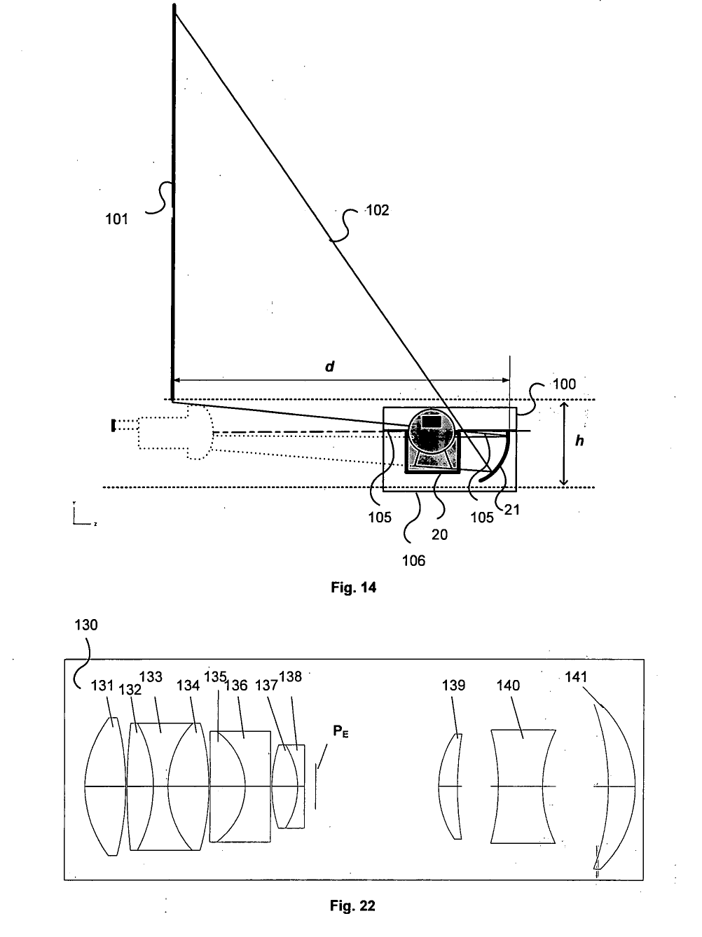

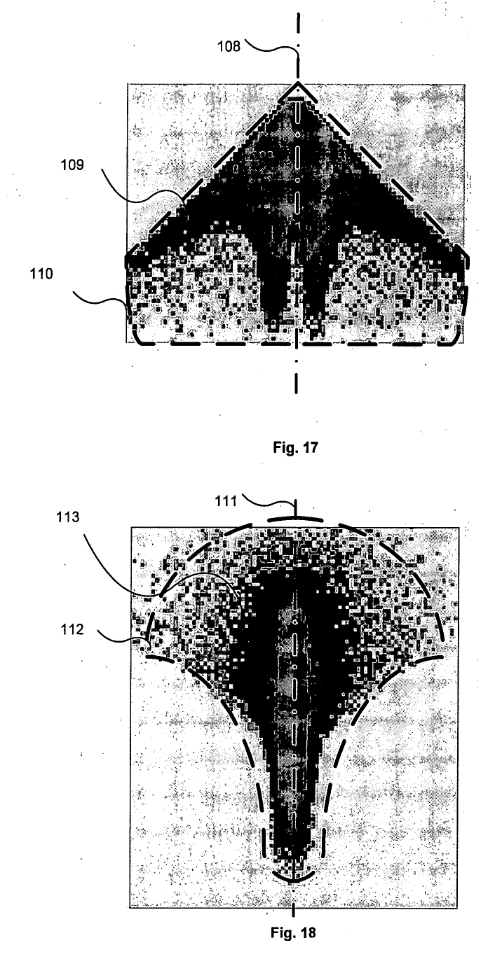

FIG. 17 illustrates a transparent mask zone 110 located 5 mm above the axis 26 near the pupillary zone P_{F}. The imprint 109 of the beam 24 is larger than that illustrated in FIGS. 14 and 15 and has an arrow tip shape. The transparent zone 110 also follows at most just the shape of the imprint 109.

FIG. 18 illustrates a transparent mask zone 112 lying 2 mm below the axis 26 near the pupillary zone P_{F}. The imprint 113 of the beam 24 is larger than that illustrated in FIGS. 14 and 15 and has a flared shape at one end. The transparent zone 112 also follows at most just the shape of the imprint 113.

FIG. 14 shows a front projector 106 in a side view. The projector 106 comprises all the elements of the projector 100, which bear the same references and will not be described further, and a mask 105. The mask 105 possesses a transparent zone letting the illumination beam through, which mask, according to various embodiments, is similar to the zones 104, 107, 110 and 112 respectively, and a black zone that absorbs the parasitic rays and extends as far as the box enclosing the optical elements of the projector 106, this black zone being similar to the black zone of the mask 103.

The masks illustrated in FIGS. 12 to 21 are preferably plane. According to other embodiments, the black zone and, where appropriate, the full transparent zone vary in shape and are such that they enclose all or some of the optical elements, including the objective, and such that the black zone does not intersect the illumination beam so as not to reduce the luminosity of the projected beam.

When the transparent zone is a full zone, part of the beam may be reflected by the transparent part. According to an alternative embodiment, the parasitic rays thus obtained may be eliminated, for example by a wall approximately normal to the mask and placed behind the transparent zone in the path of these parasitic rays outside the path of the useful projection beam.

According to an alternative embodiment of the projector, the imager is off-center relative to the cases illustrated above, thereby allowing a higher projected image to be obtained. In this way, there is also greater freedom in positioning the mask and/or greater freedom in the shape of the mask.

Of course, the invention is not limited to the embodiments described above.

In particular, the invention applies to any type of projector, whether a front projector or a rear-projector.

A person skilled in the art will also be able to define the objective and the concave folding mirror which constructs a second image in a plane of projection from a first image positioned before the concave mirror, in particular in order to adapt the astigmatism and optical distortion corrections according to particular criteria and to distribute them between the various optics of the projection system.

In addition, a person skilled in the art will be able to adapt the folding of the imaging beam according to the space constraints specific to the desired projection system.

1. A projection system comprising an imaging source and an objective that are designed to produce an imaging beam and constructing a first image positioned after the objective, said first image being off-axis relative to the optical axis of said objective,
wherein it includes a concave mirror which is positioned after said first image in the path of said imaging beam and which constructs a second image in a plane of projection from said first image, said concave mirror possessing an optical axis positioned on the optical axis of the objective, the exit pupil of the system comprising the objective and the concave mirror lying between the concave mirror and the plane of projection.

2. The system as claimed in claim 1, wherein said concave mirror is an aspherical mirror.

3. The system as claimed in claim 1, wherein it includes at least a first plane folding mirror between said objective and said concave mirror.

4. The system as claimed in claim 1, wherein said objective comprises:
a diaphragm;
a first lens group; and
a second lens group,
the second lens group being positioned after said diaphragm in the path of said imaging beam and being closer to said first image than said diaphragm.

5. The system as claimed in claim 4, wherein the distance between said second lens group and the exit pupil of said first lens groups is at least three times the distance between said first lens group and said imaging source.

6. The system as claimed in claim 4, wherein said second lens group includes at least one meniscus type lens.

7. The system as claimed in claim 4, dependent on claim 3, wherein said second lens group is positioned between said first lens group and said first folding mirror.

8. The system as claimed in claim 4, dependent on claim 3, wherein said second lens group is positioned between said first folding mirror and said concave mirror.

9. The system as claimed in claim 1, characterized in that, in a representation of the system without a folding mirror, the optical axis of said imaging beam is perpendicular to said plane of projection, being vertical when said imaging beam strikes said concave mirror.

10. The system as claimed in claim 1, wherein it includes a rear-projection screen in said plane of projection.

11. The system as claimed in claim 10, wherein it further includes at least a second plane folding mirror positioned in the path of said imaging beam between said concave mirror and said rear-projection screen.

12. The system as claimed in claim 1, wherein it includes means for front projection on said plane of projection.

13. The system as claimed in claim 1 any, wherein said objective comprises a front group comprising three lenses, the lens located in the middle having an opposite power to the outer lenses.

14. The system as claimed in claim 1, wherein it includes a mask comprising a black zone that absorbs the parasitic rays and a transparent zone placed in the path of the imaging beam after the concave mirror.

15. The system as claimed in claim 14 wherein said transparent zone is a full zone.

16. The system as claimed in claim 14, wherein said mask includes a cut-out forming said transparent zone.

17. The system as claimed in claim 14, wherein said transparent zone is positioned near the exit pupil of the system comprising the objective and the concave mirror.
